(19) United States
(12) Patent Application Publication
(10) Pub. No.: US 2015/0066443 A1
(43) Pub. Date: Mar. 5, 2015

(54) COMPUTING DEVICE AND METHOD FOR ANALYZING ASSEMBLY CLEARANCE BETWEEN TWO COMPONENTS OF PRODUCT

(71) Applicants: FU TAI HUA INDUSTRY (SHENZHEN) CO., LTD., Shenzhen (CN); HON HAI PRECISION INDUSTRY CO., LTD., New Taipei (TW)

(72) Inventors: CHIH-KUANG CHANG, New Taipei (TW); XIN-YUAN WU, Shenzhen (CN)

(21) Appl. No.: 14/472,661

(22) Filed: Aug. 29, 2014

(30) Foreign Application Priority Data
Aug. 29, 2013 (CN) 2013103853088

(51) Int. Cl. G06F 17/50; G06F 17/10

(52) U.S. Cl. CPC G06F 17/50; G06F 17/10
USPC 703/1

(57) ABSTRACT

In a method for analyzing an assembly clearance between two components of a product using a computing device, the assembly clearance between the two components is scanned to obtain a point cloud of the assembly clearance using a scanning device. The method meshes points of the point cloud to generate triangular grids, and divides the triangular grids of the point cloud into two planes of the product. The method calculates a distance between a center point of each triangular grid of an assembly plane and a base plane of the product, and stores all the distances to a clearance deviation array of the assembly clearance. A deviation analysis diagram of the assembly clearance is generated based on the clearance deviation array, and each triangular grid of the base plane of the product is highlighted using a color difference indication.

### CROSS-REFERENCE TO RELATED APPLICATIONS

This application claims priority to Chinese Patent Application No. 201310385308.8 filed on Aug. 29, 2013 in the State Intellectual Property Office of the People's Republic of China, the contents of which are incorporated by reference herein.

### FIELD

The present disclosure relates to an assembly mechanism for products, and particularly to a computing device and a method for analyzing an assembly clearance between two components of a product.

### BACKGROUND

Product may comprise one or more components. When a first component is assembled into a second component of a product, an assembly clearance between the first component and the second component is formed. In fitting two components together, for example, by inserting one component held by a hand attached to another component, it is difficult to ensure that the assembly clearance is small. Therefore, a method is adopted in which an assembly mechanism for products is needed.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 illustrates a block diagram of an example embodiment of a computing device.

FIG. 2 is a flowchart of an example embodiment of a method for analyzing an assembly clearance between two components of a product using the computing device.

FIG. 3 shows a plan view of example of a product assembly with two components.

FIG. 4 shows a plan view of example of meshing the point cloud to generate a plurality of triangular grids.

FIG. 5 is a detailed flowchart of step 23 of FIG. 2.

FIG. 6 shows a plan view of example of the deviation analysis diagram of the assembly clearance

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented. The term “module” refers to logic embodied in computing or firmware, or to a collection of software instructions, written in a programming language, such as, Java, C, or assembly. One or more software instructions in the modules may be embedded in firmware, such as in an erasable programmable read only memory (EPROM). The modules described herein may be implemented as either software and/or computing modules and may be stored in any type of non-transitory computer-readable medium or other storage device. Some non-limiting examples of non-transitory computer-readable media include CDs, DVDs, BLU-RAY, flash memory, and hard disk drives. The term “comprising” means “including, but not necessarily limited to”; it specifically indicates open-ended inclusion or membership in a so-described combination, group, series and the like.

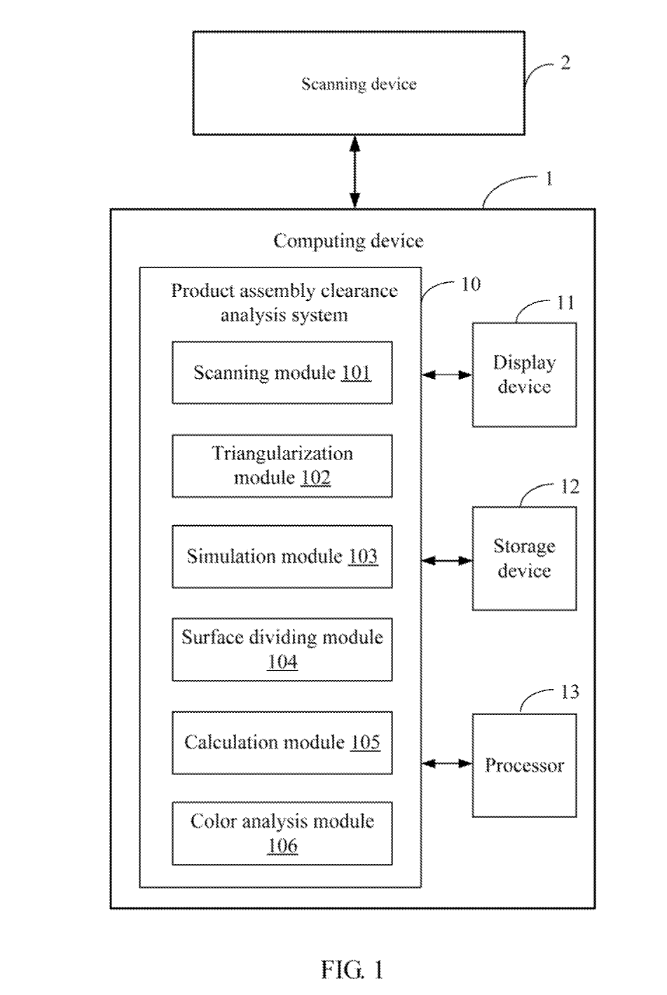

FIG. 1 illustrates a block diagram of an example embodiment of a computing device 1 including a product assembly clearance analysis system 10. In the embodiment, the computing device 1 can further include, but is not limited to, a display device 11, a storage device 12, and at least one processor 13. In one embodiment, the computing device 1 can be a personal computer, a server computer, a workstation computer, or any other suitable data processing device. The product assembly clearance analysis system 10 comprises various modules including computerized instructions in the form of one or more computer-readable programs that can be stored in a the storage device 12, and are implemented by the at least one processor 13 of the computing device 1. FIG. 1 illustrates only one example of the computing device 1, and other examples can comprise more or fewer components than those shown in the embodiment, or have a different configuration of the various components.

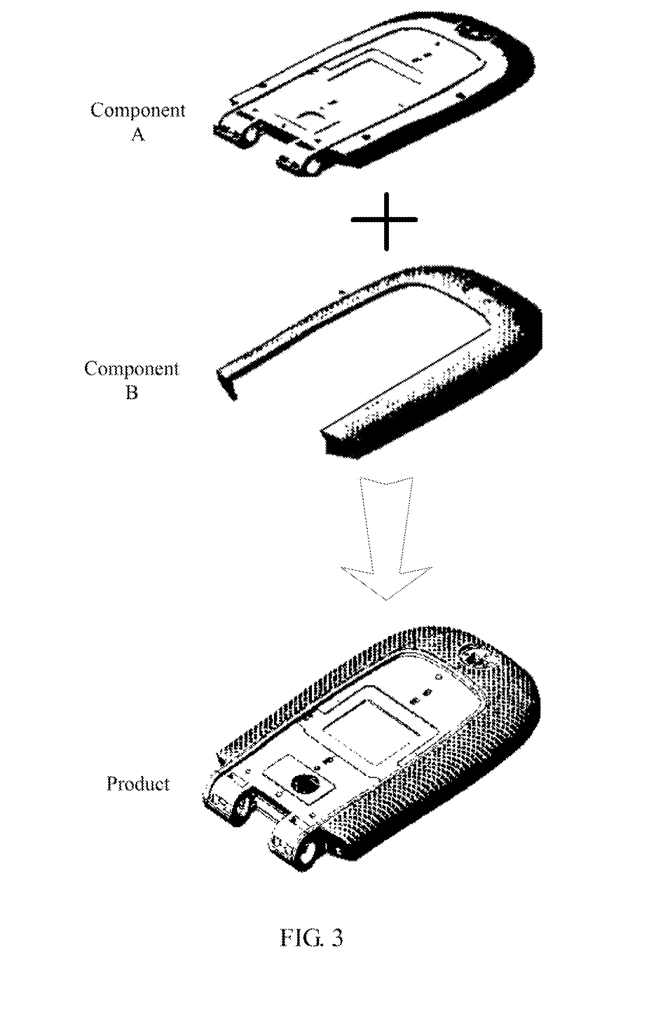

The computing device 1 connects to a scanning device 2 through an electronic wire. The scanning device 2 can be an optical three dimensional (3D) scanner, or a 3D charge-coupled device. The scanning device 2 scans an assembly clearance between two components of a product to obtain a cloud point of the assembly clearance, and sends the point cloud comprising point datum to the computing device 1. The computing device 1 analyzes the point cloud of the assembly clearance to generate a deviation analysis diagram of the assembly clearance, and displays the deviation analysis diagram of the assembly clearance on the display device 11. In the embodiment, the product may comprise one or more components, as shown in FIG. 3.

In one embodiment, the storage device 12 can be an internal storage system, such as a flash memory, a random access memory (RAM) for temporary storage of information, and/or a read-only memory (ROM) for permanent storage of information. The storage device 12 can also be an external storage system, such as an external hard disk, a storage card, or a data storage medium. The at least one processor 13 can be a central processing unit (CPU), a microprocessor, or other data processing chip that performs various functions of the computing device 1.

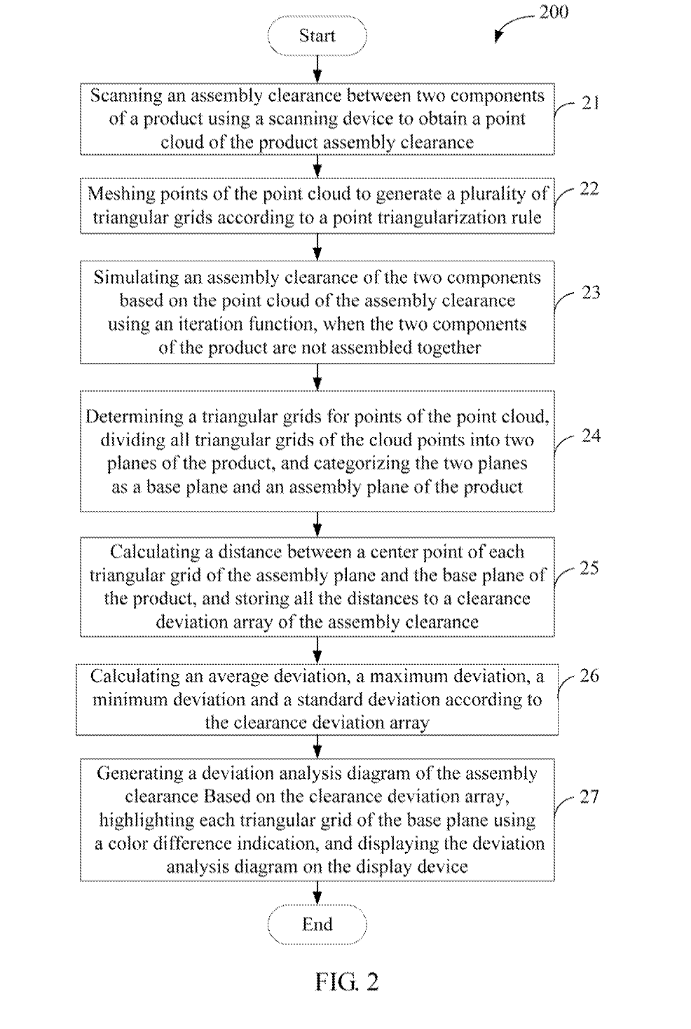

In the embodiment, the product assembly clearance analysis system 10 can comprise, but is not limited to, a scanning module 101, a triangularization module 102, a simulation module 103, a surface dividing module 104, a calculation module 105, and a color analysis module 106. The modules 101-106 can comprise computerized instructions in the form of one or more computer-readable programs that can be stored in a non-transitory computer-readable medium, such as the storage device 12, and be executed by the at least one processor 13 of the computing device 1. The modules 101-106 can be include the computerized instructions to execute the method as described below in relation to FIG. 2.

FIG. 2 illustrates a flowchart of an example embodiment of a method for analyzing an assembly clearance between two components of a product using a computing device. In the example embodiment, the method is performed by execution of computer-readable software program codes or instructions by at least one processor of the computing device 1. The method can automatically analyze an assembly clearance between two components of the product to generate a deviation analysis diagram of the assembly clearance, and displays the deviation analysis diagram of the assembly clearance on the display device 11.

Referring to FIG. 2, a flowchart is presented in accordance with an example embodiment which is being thus illustrated. In the embodiment, the example method 200 is provided by way of example only as there are a variety of ways to carry out the method. The method 200 described below can be carried out using the configurations illustrated in FIG. 1, for example, and various elements of these figures are referenced in explaining the example method 200. Each block shown in FIG. 2 represents one or more processes, methods or subroutines, carried out in the exemplary method 200. Additionally, the illustrated order of blocks is by example only and the order of the blocks can be changed according to the present disclosure. The exemplary method 200 can begin at block 21.

At block 21, a scanning module scans an assembly clearance between two components of the product using the scanning device 2 to obtain a point cloud of the assembly clearance, when the two components are assembled together. FIG. 3 shows a plan view of example of a product assembly with two components. When a first component (e.g., component A) is assembled into a second component (e.g., component B) of the product, the assembly clearance between the first component and the second component of the product is formed.

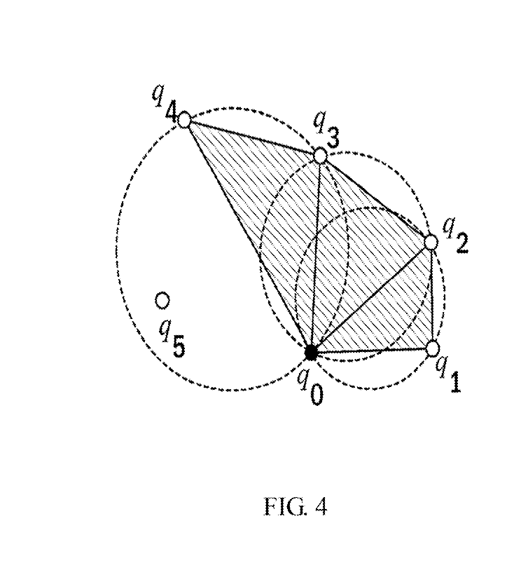

At block 22, a triangularization module meshes all points of the point cloud to generate a plurality of triangular grids according to a point triangularization rule. In one embodiment, the point triangularization rule is described as: reading a first point and a second point nearest to the first point from the point cloud, where the first point and the second point are one side of a triangle; and determining a third point of the triangle that there is no point in a circumcircle of the triangle which is consisting of the first point, the second point and the third point. FIG. 4 shows a plan view of example of meshing the point cloud to generate a plurality of triangular grids. The triangularization module reads a first point q1 and a second point q2 nearest to the first point q1 from the point cloud, where the first point q1 and the second point q2 construct one side of a triangle, and determines a third point q3 of the triangle that there is no point in a circumcircle of the triangle which consists of the first point q1, the second point q2, and the third point q3.

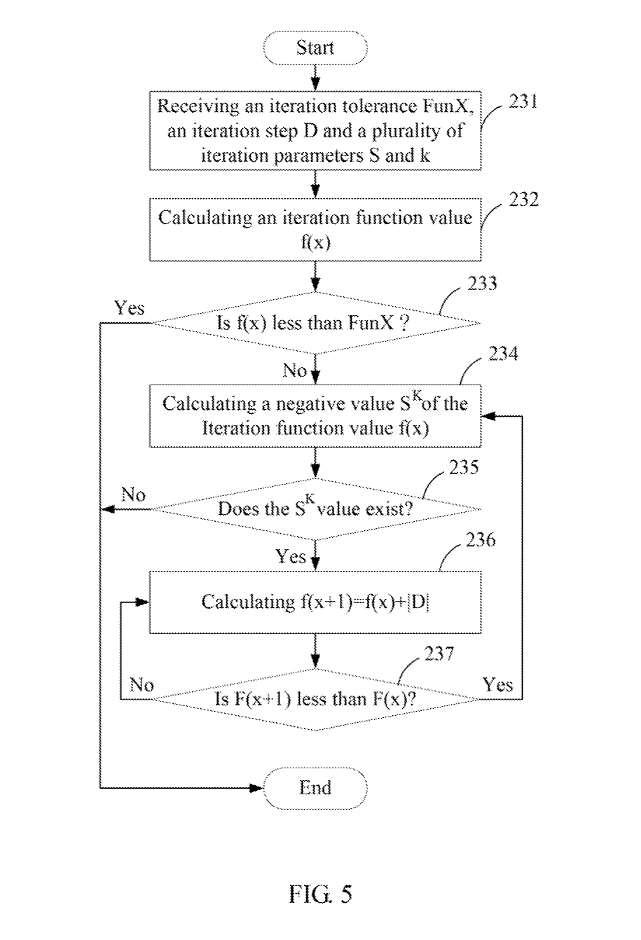

At block 23, a simulation module simulates an assembly clearance of the two components based on the point cloud of the assembly clearance using an iteration function, when the two components of the product are not assembled together. In the embodiment, the iteration function is performed based on the point cloud of the assembly clearance, and is described in FIG. 5.

At block 24, a surface dividing module determines a triangular grid for each point of the point cloud, and divides all triangular grids of the point cloud into two planes of the product, and categorizes the two planes as a base plane and an assembly plane of the product. In the embodiment, the surface dividing module determines one of the two planes as a base plane of the product, and determines the other plane as an assembly plane of the product. The base plane serves as a reference plane relative to the assembly plane of the product. Referring to FIG. 3, the component A is specified as the base plane, and the component B is specified as the assembly plane. The surface dividing module divides one of the triangular grids related to the component A into the base plane of the product, and divides the other triangular grids related to the component B into the assembly plane of the product.

At block 25, a calculation module calculates a distance between a center point of each triangular grid of the assembly plane and the base plane of the product, and stores all the calculated distances to a clearance deviation array of the assembly clearance. In the embodiment, the calculation module stores all distances into the clearance deviation array as clearance deviations of the assembly clearance.

At block 26, the calculation module calculates an average deviation, a maximum deviation, a minimum deviation and a standard deviation of the assembly clearance based on the clearance deviation array. In the embodiment, the average deviation equals the sum of the clearance deviations divided by the number of the clearance deviations in the clearance deviation array. The maximum deviation is a maximum value of the clearance deviation array, and the minimum deviation is a minimum value of the clearance deviation array. The standard deviation is calculated as

$$devs = \sqrt{\sum {( x - \overline{x} )}^{2} / ( n - 1 )} ,$$

where x is the average deviation, and n is the number of the clearance deviations in the clearance deviation array.

At block 27, the color analysis module generates a deviation analysis diagram of the assembly clearance according to the clearance deviation array, highlights each triangular grid of the base plane of the product using a color difference indication, and displays the deviation analysis diagram on the display device 11. In the embodiment, the color difference indication is used to indicate the each triangular grid of the base plane of the product, and is predefined according to the tolerance of the assembly clearance.

FIG. 5 is an example embodiment of a detailed flowchart of step 23 of FIG. 2. In the embodiment, the simulation module performs an iteration function to simulate a assembly clearance of the two components based on the point cloud of the assembly clearance.

At block 231, the simulation module receives an iteration tolerance (denoted as FunX), an iteration step (denoted as D) and a plurality of iteration parameters (denoted as S and k, respectively) which are inputted by a user from an input device of the computing device 1. The iteration tolerance FunX can be set as 0.2 mm, for example. The iteration step D can be set as 0.1 mm, for example. The iteration parameters S and k can form a function value S^{k} of the iteration function.

At block 232, the simulation module calculates an iteration function value f(x). In the embodiment, the iteration function value f(x) is calculated according to the iteration function:

$$f ( x ) = \sqrt[M i n]{\sum {( \sqrt{{x 2 - x 1 )}^{2} + {( y 2 - y 1 )}^{2} + {( z 2 - z 1 )}^{2}} )}^{2} / n} ,$$

where (x1, y1, z1) represents coordinates of each point in the base plane of the product, (x2, y2, z2) represents coordinates of each point in the assembly plane of the product, and n represents a total number of points of the point cloud.

At block 233, the simulation module determines whether the iteration function value f(x) is less than the iteration tolerance FunX. If the iteration function value f(x) is not less than the iteration tolerance FunX, block 234 is implemented. Otherwise, if the iteration function f(x) is less than the iteration tolerance FunX, block 24 is implemented.

At block 234, the simulation module calculates a negative value (denoted as S^{k}) of the iteration function value f(x). The negative value S^{k} represents the iteration function having decreasing function value f(x)=S^{k}.

At block 235, the simulation module determines whether the iteration function has the negative value S^{k}. If the iteration function has the negative value S^{k}, block 236 is implemented. Otherwise, if the iteration function has no negative value S^{k}, block 24 is implemented.

At block 236, the simulation module calculates a next iteration function value f(x+1)=f(x)+|D|, wherein D is the iteration step as described above.

At block 236, the simulation module determines whether the next iteration function value f(x+1) is less than the iteration function value f(x). If the next iteration function value f(x+1) is less than the iteration function value f(x), block 234 is implemented. Otherwise, if the next iteration function value f(x+1) is not less than the iteration function value f(x), block 236 is implemented.

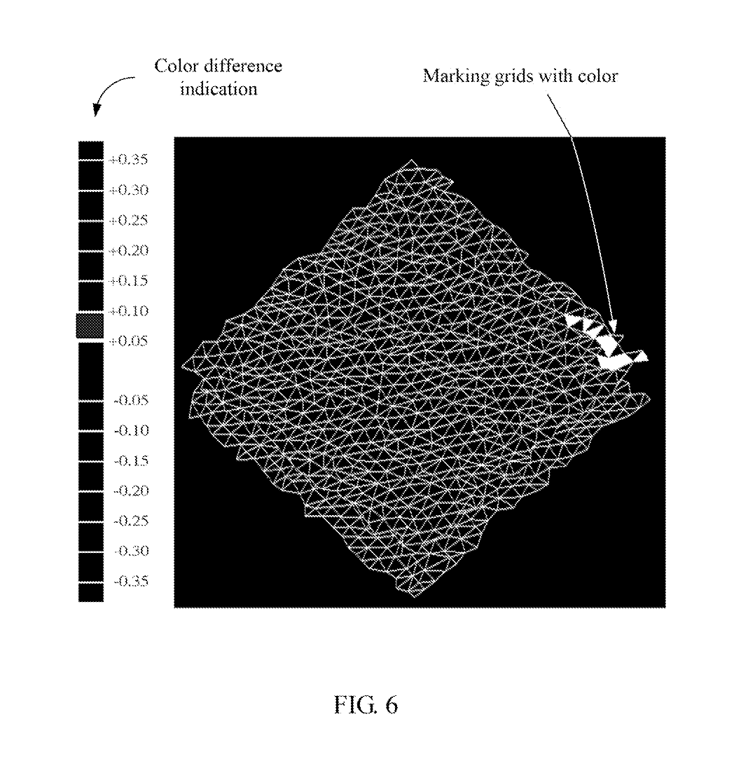

FIG. 6 shows a plan view of example of the deviation analysis diagram of the assembly clearance. In the example embodiment, the triangular grids of the base plane of the product are colored in the deviation analysis diagram according to the color difference indication, and the deviation analysis diagram can be displayed on the display device 11. As such, the user can easily determine or analyze whether the assembly clearance between two components of the product is qualified based on the deviation analysis diagram.

All of the processes described above may be embodied in, and fully automated via, functional code modules executed by one or more general purpose processors of computing devices. The code modules may be stored in any type of non-transitory readable medium or other storage device. Some or all of the methods may alternatively be embodied in specialized hardware. Depending on the embodiment, the non-transitory computer-readable medium may be a hard disk drive, a compact disc, a digital video disc, a tape drive or other suitable storage medium.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in particular the matters of shape, size and arrangement of parts within the principles of the present disclosure, up to and including the full extent established by the broad general meaning of the terms used in the claims.

What is claimed is:

1. A computing device comprising:
at least one processor, and
a storage device storing a computer-readable program comprising instructions that, when executed by the at least one processor, causes the at least one processor to:
scan an assembly clearance between two components of a product using a scanning device;
obtain, based on the scan, a point cloud of the assembly clearance, with a plurality of points;
mesh the plurality of points to generate a plurality of triangular grids;
divide the plurality of triangular grids into two planes of the product;
categorize the two planes as a base plane and an assembly plane of the product;
calculate a distance between a center point of each triangular grid of the assembly plane and the base plane of the product;
store the calculated distances to a clearance deviation array of the assembly clearance;
generate a deviation analysis diagram of the assembly clearance based on the clearance deviation array;
highlight each triangular grid of the base plane using a color difference indication; and
display the deviation analysis diagram on a display device.

2. The computing device according to claim 1, wherein the scanning device is an optical three dimensional (3D) scanner or a 3D charge-coupled device that is connected to the computing device.

3. The computing device according to claim 1, wherein the plurality of points are meshed to generate the plurality of triangular grids by operations comprising:
reading a first point and a second point nearest to the first point from the point cloud, where the first point and the second point are one side of a triangle; and
determining a third point of the triangle that there is no point in a circumcircle of the triangle which is consisting of the first point, the second point and the third point.

4. The computing device according to claim 1, wherein the computer-readable program further causes the at least one processor to calculate an average deviation, a maximum deviation, a minimum deviation and a standard deviation of the assembly clearance according to the clearance deviation array.

5. The computing device according to claim 4, wherein the average deviation equals sum of the clearance deviations divided by the number of the clearance deviations in the clearance deviation array, the maximum deviation is a maximum value of the clearance deviation array, the minimum deviation is a minimum value of the clearance deviation array, and the standard deviation is calculated as
$$devs = \sqrt{\sum {( x - \overline{x} )}^{2} / ( n - 1 )} ,$$
wherein x is the average deviation, and n is a total number of the clearance deviations in the clearance deviation array

6. The computing device according to claim 1, wherein the computer-readable program further causes the at least one processor to simulate the assembly clearance of the two components based on the point cloud of the assembly clearance using an iteration function when the two components are not assembled together.

7. The computing device according to claim 6, wherein the iteration function is performed by operations comprising:
(a) receiving an iteration tolerance FunX, an iteration step D and a plurality of iteration parameters inputted from the computing device;
(b) calculating an iteration function value f(x)
$$f ( x ) = \sqrt[M i n]{\sum {( \sqrt{{x 2 - x 1 )}^{2} + {( y 2 - y 1 )}^{2} + {( z 2 - z 1 )}^{2}} )}^{2} / n} ,$$
wherein (x1, y1, z1) represents coordinates of each point in the base plane of the product, and (x2, y2, z2) represents coordinates of each point in the assembly plane of the product, n represents a total number of points of the point cloud;
(c) determining whether the iteration function value f(x) is less than the iteration tolerance;
(d) calculating a negative value of the iteration function value f(x) if the iteration function value f(x) is not less than the iteration tolerance, or ending to execute the iteration function if the iteration function f(x) is less than the iteration tolerance;
(e) determining the iteration function has the negative value;
(f) calculating a next iteration function value f(x+1)=f(x)+|D|, if the iteration function has the negative value, or ending to execute the iteration function if the iteration function has no negative value;
(g) determining whether the next iteration function value f(x+1) is less than the iteration function value f(x); and
(h) repeating from block (d) to block (g) if the next iteration function value f(x+1) is less than the iteration function value f(x), or repeating from block (f) to block (g), if the next iteration function value f(x+1) is not less than the iteration function value f(x).

8. A method for analyzing an assembly clearance between two components of a product using a computing device, the method comprising:
scanning the assembly clearance between two components using a scanning device;
obtaining, based on the scanning, a point cloud of the assembly clearance, with a plurality of points;
meshing the plurality of points to generate a plurality of triangular grids;
dividing the plurality of triangular grids into two planes of the product;
categorizing the two planes as a base plane and an assembly plane of the product;
calculating a distance between a center point of each triangular grid of the assembly plane and the base plane of the product;
storing the calculated distances to a clearance deviation array of the assembly clearance;
generating a deviation analysis diagram of the assembly clearance based on the clearance deviation array;
highlighting each triangular grid of the base plane using a color difference indication; and
displaying the deviation analysis diagram on a display device.

9. The method according to claim 8, wherein the scanning device is an optical three dimensional (3D) scanner or a 3D charge-coupled device that is connected to the computing device.

10. The method according to claim 8, wherein the plurality of points are meshed to generate the plurality of triangular grids by operations comprising:
reading a first point and a second point nearest to the first point from the point cloud, where the first point and the second point are one side of a triangle; and
determining a third point of the triangle that there is no point in a circumcircle of the triangle which is consisting of the first point, the second point and the third point.

11. The method according to claim 8, further comprising:
calculating an average deviation, a maximum deviation, a minimum deviation and a standard deviation of the assembly clearance according to the clearance deviation array.

12. The method according to claim 11, wherein the average deviation equals sum of the clearance deviations divided by the number of the clearance deviations in the clearance deviation array, the maximum deviation is a maximum value of the clearance deviation array, the minimum deviation is a minimum value of the clearance deviation array, and the standard deviation is calculated as
$$devs = \sqrt{\sum {( x - \overline{x} )}^{2} / ( n - 1 )} ,$$
wherein x is the average deviation, and n is a total number of the clearance deviations in the clearance deviation array

13. The method according to claim 8, further comprising:
simulating the assembly clearance of the two components based on the point cloud of the assembly clearance using an iteration function when the two components are not assembled together.

14. The method according to claim 13, wherein the iteration function is performed by operations comprising:
(a) receiving an iteration tolerance FunX, an iteration step D and a plurality of iteration parameters inputted from the computing device;
(b) calculating an iteration function value f(x)
$$f ( x ) = \sqrt[M i n]{\sum {( \sqrt{{x 2 - x 1 )}^{2} + {( y 2 - y 1 )}^{2} + {( z 2 - z 1 )}^{2}} )}^{2} / n} ,$$
wherein (x1, y1, z1) represents coordinates of each point in the base plane of the product, and (x2, y2, z2) represents coordinates of each point in the assembly plane of the product, n represents a total number of points of the point cloud;
(c) determining whether the iteration function value f(x) is less than the iteration tolerance;
(d) calculating a negative value of the iteration function value f(x) if the iteration function value f(x) is not less than the iteration tolerance, or ending to execute the iteration function if the iteration function f(x) is less than the iteration tolerance;
(e) determining the iteration function has the negative value;
(f) calculating a next iteration function value f(x+1)=f(x)+|D|, if the iteration function has the negative value, or ending to execute the iteration function if the iteration function has no negative value;
(g) determining whether the next iteration function value f(x+1) is less than the iteration function value f(x); and
(h) repeating from block (d) to block (g) if the next iteration function value f(x+1) is less than the iteration function value f(x), or repeating from block (f) to block (g), if the next iteration function value f(x+1) is not less than the iteration function value f(x).

15. A non-transitory storage medium having stored thereon instructions that, when executed by at least one processor of a computing device, causes the least one processor to execute instructions of a method for analyzing an assembly clearance between two components of a product, the method comprising:
scanning the assembly clearance between two components using a scanning device;
obtaining, based on the scanning, a point cloud of the assembly clearance, with a plurality of points;
meshing the plurality of points to generate a plurality of triangular grids;
dividing the plurality of triangular grids into two planes of the product;
categorizing the two planes as a base plane and an assembly plane of the product;
calculating a distance between a center point of each triangular grid of the assembly plane and the base plane of the product;
storing the calculated distances to a clearance deviation array of the assembly clearance;
generating a deviation analysis diagram of the assembly clearance based on the clearance deviation array;
highlighting each triangular grid of the base plane using a color difference indication; and
displaying the deviation analysis diagram on a display device.

16. The storage medium according to claim 15, wherein the scanning device is an optical three dimensional (3D) scanner or a 3D charge-coupled device that is connected to the computing device.

17. The storage medium according to claim 15, wherein the plurality of points are meshed to generate the plurality of triangular grids by operations comprising:
reading a first point and a second point nearest to the first point from the point cloud, where the first point and the second point are one side of a triangle; and
determining a third point of the triangle that there is no point in a circumcircle of the triangle which is consisting of the first point, the second point and the third point.

18. The storage medium according to claim 15, wherein the method further comprises:
calculating an average deviation, a maximum deviation, a minimum deviation and a standard deviation of the assembly clearance according to the clearance deviation array.

19. The storage medium according to claim 18, wherein the average deviation equals sum of the clearance deviations divided by the number of the clearance deviations in the clearance deviation array, the maximum deviation is a maximum value of the clearance deviation array, the minimum deviation is a minimum value of the clearance deviation array, and the standard deviation is calculated as
$$devs = \sqrt{\sum {( x - \overline{x} )}^{2} / ( n - 1 )} ,$$
wherein x is the average deviation, and n is a total number of the clearance deviations in the clearance deviation array

20. The storage medium according to claim 15, wherein the method further comprises:
simulating the assembly clearance of the two components based on the point cloud of the assembly clearance using an iteration function when the two components are not assembled together, wherein the iteration function is performed by operations comprising:
(a) receiving an iteration tolerance FunX, an iteration step D and a plurality of iteration parameters inputted from the computing device;
(b) calculating an iteration function value f(x)
$$f ( x ) = \sqrt[M i n]{\sum {( \sqrt{{x 2 - x 1 )}^{2} + {( y 2 - y 1 )}^{2} + {( z 2 - z 1 )}^{2}} )}^{2} / n} ,$$
wherein (x1, y1, z1) represents coordinates of each point in the base plane of the product, and (x2, y2, z2) represents coordinates of each point in the assembly plane of the product, n represents a total number of points of the point cloud;
(c) determining whether the iteration function value f(x) is less than the iteration tolerance;
(d) calculating a negative value of the iteration function value f(x) if the iteration function value f(x) is not less than the iteration tolerance, or ending to execute the iteration function if the iteration function f(x) is less than the iteration tolerance;
(e) determining the iteration function has the negative value;
(f) calculating a next iteration function value f(x+1)=f(x)+|D|, if the iteration function has the negative value, or ending to execute the iteration function if the iteration function has no negative value;
(g) determining whether the next iteration function value f(x+1) is less than the iteration function value f(x); and
(h) repeating from block (d) to block (g) if the next iteration function value f(x+1) is less than the iteration function value f(x), or repeating from block (f) to block (g), if the next iteration function value f(x+1) is not less than the iteration function value f(x).
